(19) United States
(12) Patent Application Publication
(10) Pub. No.: US 2005/0025874 A1
(43) Pub. Date: Feb. 3, 2005

(54) Low phosphorus animal feed and method for making same

(76) Inventor: Ting L. Carlson, Dayton, OH (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/898,097

(22) Filed: Jul. 22, 2004

Related U.S. Application Data
(63) Continuation of application No. PCT/US03/02354, filed on Jan. 24, 2003.
(60) Provisional application No. 60/351,725, filed on Jan. 24, 2002.

(51) Int. Cl. A23K 1/00

(52) U.S. Cl. 426/635

(57) ABSTRACT

A low phosphorus animal feed and a method for making same by precipitating phytate from steepwater is described.

### FIELD OF THE INVENTION

This invention relates to animal feed with a reduced phosphorus content and a process for making such a feed.

### BACKGROUND

Corn gluten feed is primarily used for cattle feeding and has about four times the amount of phosphorus needed by animals for nutrition. Moreover, much of the phosphorus is in the undesirable form of phytate [mysoinsoitol 1,2,3,4,5,6-hexakis(dihydrogen phosphate)].

In wet milling of corn for corn starch or for corn syrup, kernel residues remain that include corn germ, corn bran, and corn solubles. The wet milling of corn includes steeping of the corn prior to breaking the corn. Most of the phosphorus in corn is in the form of an organic phosphorus containing compound, phytate. Steeping among other things leaches phytate out of the corn into steepwater and ideally the steepwater is used as part of the animal feed once it is evaporated to about 50% solids. Corn steep liquor is also used as a nutrient source for various fermentation processes.

Phytate is poorly digested by monogastric animals. Ruminants, such as cattle, can digest phytate through microorganisms found in the gastrointestinal tract and hence utilize released phosphate, but excess dietary phytate and phosphate consumed by a ruminant animal will pass through its gastrointestinal tract, be excreted as manure and become environmentally damaging in areas of extensive livestock production. This is because excessive amounts of phosphorus enter the environment and the aquifer from the animal manure. A further problem with phytate is that it associates with multivalent cations which may be nutritionally needed by the animal, and thus interfere with the bio-availability of these cations to the animal.

### OBJECTS

An object of the invention is to provide an animal feed with a reduced phosphorus content and a method for making same.

Another object of the invention is to provide a corn gluten feed with a reduced phosphorus content and a reduced phytate content.

Another object of this invention is to provide a reduced phosphorus animal feed ingredient.

Another objective of this invention is to provide a reduced phosphorus nutrient source for fermentation.

Another object of the invention is to provide a stable animal feed that will remain edible for longer times.

These and other objects of the invention will become apparent by reference to the following specification.

### SUMMARY

The invention provides a method for making an animal feed having a low phosphorus content. The invention also contemplates a corn gluten feed or animal feed which includes a steepwater product of the invention which steepwater has a phosphorus content which is not more than about 25 weight percent of the phosphorus content of the steepwater from which the low phosphorus steepwater has been made and which has not been reduced in phosphorus content. Also, the invention includes the low phosphorus steepwater as a nutrient source for fermentation and producing a fermentation product.

The method contemplates using steepwater from wet corn milling and removing the phytate from the steepwater by mixing the steepwater with an alkaline hydroxide, such as calcium hydroxide, magnesium hydroxide, ammonium hydroxide and mixtures thereof, to convert the phytate to an alkaline metal salt and/or ammonium salt (phytin) and to precipitate the phytin in the steepwater to provide a phytin precipitated steepwater. The alkaline metal and/or ammonium hydroxide is in an amount effective to precipitate the phytate in the steepwater and to provide an alkaline metal or ammonium phytin complex or associate the divalent metal and/or ammonium ion with the phytin such that the phytin will precipitate with the calcium metal, magnesium metal and/or ammonium ions. Calcium ions, however, are a very important aspect of the invention and work better to precipitate phosphorus than other ions even when the other ions are in an environment having a high pH. The alkaline metal or ammonium ions also complex and precipitate a small amount of inorganic phosphate in steepwater. Generally the alkaline metal and/or ammonium hydroxide will be present in amount to provide a pH of greater than about 5.5 and preferably greater than about 6.0, and a Ca/P molar ratio which is effective to precipitate at least 75% and preferably 80% of the phosphorus, which ratio is at least about 1.0, preferably at least about 1.2. Thereafter the ion/phytin complex is separated from the steepwater to provide a low phosphorus steepwater. After separation of the precipitated phytin from the steepwater, the low phosphorus steepwater is evaporated and combined with other animal feed ingredients to provide a low phosphorus content animal feed having not more than about 25 weight percent phosphorus than the comparable animal feed containing the untreated high phosphorus steepwater. Feed ingredients that may be combined with the low phosphorous steepwater include corn grains such as corn kernels, cereal grain by-products such as corn by-products, legumes such as soy beans, legume by-products such as soy hulls, and mixtures thereof.

In one aspect the low phosphorus content steepwater is fermented at a time and temperature to decrease the pH of the low phosphorus content steepwater to less than about 5, preferably to a pH in the range of about 3.8 to about 4.6. The fermentation may be conducted with endogenous bacteria, with added lactic acid bacteria, and/or propionate producing bacteria. The fermentation is important because it converts residual sugar in the steepwater into organic acid, such as, for example, lactic acid, which lowers the pH of the steepwater and thereby enhances the stability of the steepwater. Low steepwater pH also increases the solubility of steep solids and minimizes precipitate formation during the evaporation process of corn steep liquor. The fermentation also is effective for reducing the sugar content in the steepwater in an amount such that browning reactions do not deleteriously affect the color of the feed as a result of drying the feed. The fermentation is also effective for providing a low phosphorus steepwater which when blended with feed provides a feed having at least about 1 pound of propionate per ton of feed. In one aspect, propionic bacteria should be used to conduct a fermentation which forms sufficient propionate which is effective for inhibiting mold formation in the steepwater and subsequent animal feed compared to the same product which has not undergone such fermentation.

Steepwater fermentation may be conducted with all of the steepwater or with part of the steepwater. In this aspect, an amount of steepwater is removed which is effective for providing a fermented steepwater that can be recombined with the remaining steepwater to provide a stable low phosphorus steepwater. Generally about 10% to about 100% of the total volume of steepwater may be fermented, preferably about 10% of the total volume of steep water is fermented.

In another aspect, the invention contemplates a unique corn gluten feed and method for making that feed. The method includes steeping corn in water to provide a steeped corn and steepwater. The steepwater is drained or separated from the steeped corn. The steeped corn is wet milled into at least two basic fractions a corn kernel fiber fraction (which would include fiber rich bran and germ) and a non-fiber corn fraction. The separated steepwater is mixed with a hydroxide selected from the group consisting of calcium hydroxide, magnesium hydroxide, ammonium hydroxide, and mixtures thereof to precipitate at least about 75 weight percent of the phosphorus in the steepwater and to provide a phytin precipitated steepwater. The hydroxide is in an amount effective to precipitate the phytate in the steepwater and to provide a phytin complex which precipitates in the steepwater. The precipitated phytin is separated from the steepwater such as by filtration, centrifugation, coagulation, flocculation, sedimentation and absorption to provide a low phosphorus steepwater. The low phosphorus steepwater may be concentrated to about 30 to about 90% by weight solids, preferably about 50% by weight solids. The low phosphorus steepwater then is mixed with other animal feed ingredients such as those described above.

In another aspect, the invention is effective for removing oxalates in the steepwater. Oxalate removal is important because during subsequent concentration steps, oxalate forms insoluble complexes, such as calcium oxalate, that form scales and cause fouling of processing equipment. When steepwater is mixed with an alkaline metal hydroxide and/or ammonium hydroxide as described above, the alkaline metal hydroxide is effective for precipitating at least about 80 weight percent of the oxalate in the steepwater to provide alkaline metal oxalate complexes.

The invention further relates to the use of steepwater for fermentation and production of a fermentation product where the steepwater has a phosphorus content of 1 to 99 weight % of the phosphorus content of the source steepwater. In an important aspect, the invention includes a process for preparing a fermentation product that includes fermenting a steepwater having a phosphorus content that is not more than 25 weight percent of the phosphorus content of a source steepwater which has not been reduced in phosphorus.

### DESCRIPTION OF THE DRAWINGS

FIG. 1 generally illustrates a method for producing a low phosphorus animal feed.

FIG. 2 generally illustrates a method for producing a low phosphorus animal feed where low phosphorus steepwater is fermented prior to combining it with a corn kernel fiber fraction.

FIG. 3 genereally illustrates a method for producing a low phosphorus animal feed where a portion of the low phosphorus steepwater is fermented, recombined with remaining low phosphorus steepwater and then combined with a corn kernel fiber fraction.

FIG. 4 shows total P precipitation in light steepwater at various pHs and calcium to phosphorus ratios.

FIG. 5 shows mold scores of wet feed prepared by mixing the feed with steepwater, low phosphorus steepwater, or fermented low phosphorus steepwater.

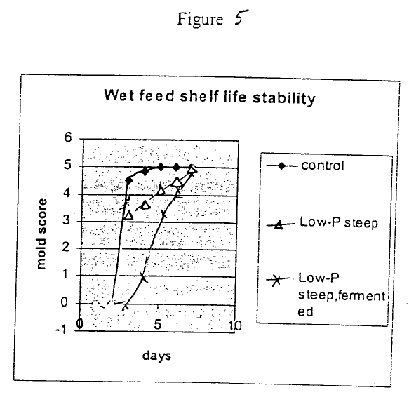

### DETAILED DESCRIPTION

Definitions

“Phytate” means myoinositol 1,2,3,4,5,6-hexakis(dihydrogen phosphate. This compound associates with cations and forms complexes which are sometimes called phytin. We shall also describe these metal or ammonium ion/phytate associated molecules as phytin complexes.

“Corn gluten feed” is a by-product of the wet milling of corn for products such as corn starch and corn syrup. Corn gluten feed generally includes corn germ, corn bran, corn solubles, cracked corn, and fermentation end products.

Components of the Maize (Corn) Kernel

Botanically, a maize kernel is known as a caryopsis, a dry, one-seeded, nutlike berry in which the fruit coat and the seed are fused to form a single grain. Mature kernels are composed of four major parts: pericarp (hull or bran), germ (embryo), endosperm and tip cap.

An average composition of whole maize, and its fractions, on a moisture-free (dry) basis is as follows:

TABLE 1

| Fraction | | | | | | |
|---|---|---|---|---|---|---|
| of Whole | Kernel | Starch | Protein | Liquid | Sugar | Ash |
| Maize | % | % | % | % | % | % |
| Whole | 100 | 71.5 | 10.3 | 4.8 | 2.0 | 1.4 |
| grain | | | | | | |
| Endosperm | 82.3 | 86.4 | 9.4 | 0.8 | 0.6 | 0.3 |
| Germ | 11.5 | 8.2 | 18.8 | 34.5 | 10.8 | 10.1 |
| Pericarp | 5.3 | 7.3 | 3.7 | 1.0 | 0.3 | 0.8 |
| Tip cap | 0.8 | 5.3 | 9.1 | 3.8 | 1.6 | 1.6 |

Germ: The scutellum and the embryonic axis are the two major parts of the germ. The scutellum makes up 90% of the germ, and stores nutrients mobilized during germination. During this transformation, the embryonic axis grows into a seedling. The germ is characterized by its high fatty oil content. It is also rich in crude proteins, sugars, and ash constituents. The scutellum contains oil-rich parenchyma cells which have pitted cell walls. Of the sugars present in the germ, about 67% is glucose.

Endosperm: The endosperm contains the starch, and is lower in protein content than the germ and the bran. It is also low in crude fat and ash constituents.

Pericarp: The maize kernel is covered by a water-impermeable cuticle. The pericarp (hull or bran) is the mature ovary wall which is beneath the cuticle, and comprises all the outer cell layers down to the seed coat. It is high in non-starch-polysaccarides, such as cellulose and pentosans. A pentosan is a complex carbohydrate present in many plant tissues, particularly brans, characterized by hydrolysis to give five-carbon-atom monosaccharides (pentoses). It is any member of a group of pentose polysaccharides having the formula (C₅H₈O₄)ₙ found in various foods and plant juices. Because of its high fiber content, the pericarp is tough.

Tip cap: The tip cap, where the kernel is joined to the cob, is a continuation of the pericarp, and is usually present during shelling. It contains a loose and spongy parenchyma.

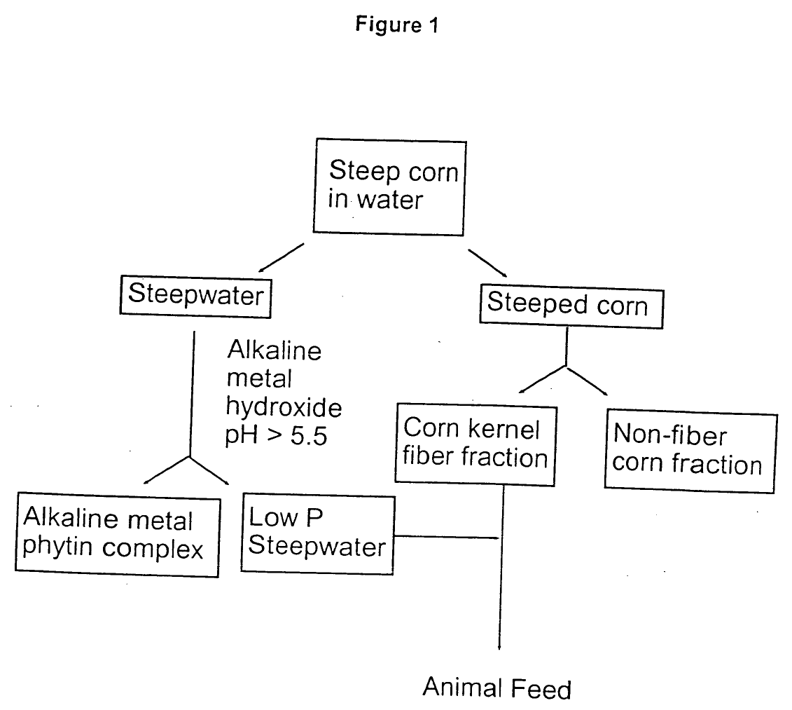

As shown in FIG. 1, the first step in the wet milling of corn is steeping which is the soaking of the corn in water under controlled processing conditions of temperature, time, sulfur dioxide (SO₂) concentration, and lactic acid content. These conditions have been found necessary to promote diffusion of the water through the tip cap of the corn kernel into the germ and endosperm. Steeping softens the kernels, facilitating separation of the components of corn.

Bulk corn is cleaned on vibrating screens to remove coarse material and fine material. These screenings removed from the corn kernels are used for animal feed. If they are allowed to remain with the corn, they cause processing problems such as restricted water flow through steeps and screens and increased steep liquor viscosity.

Steeping is accomplished by putting corn into tanks and covering the corn with water. The corn and water blend may be heated to about 125° F. and held for about 22 to about 50 hours. Steeping may be done by continuously adding dry corn at the top of the steep while continuously withdrawing steeped corn from the bottom.

Water from the steeping accumulates corn solubles. The water is treated with SO₂ to a concentration of about 0.12 to about 0.20 weight percent. The SO₂ increases the rate of water diffusion into the kernel and assists in breaking down the protein-starch matrix, which is necessary for high starch yield and quality.

Water moves from one steep tank to another and as the water is advanced from steep to steep, the SO₂ content decreases and bacterial action increases. This results in the growth of lactic acid bacteria. The lactic acid concentration is from about 16 to about 20% (dry basis) after the water has advanced through the steeping system and been withdrawn as light steepwater (steepwater without water evaporated therefrom). Meanwhile, the SO₂ content drops to about 0.01% or less.

During steeping some water is absorbed by the corn to increase its moisture from about 16 to about 45 weight percent. The remaining water not absorbed is withdrawn from the steeping system. This light steepwater contains the solubles soaked out of the corn. The steepwater is mixed with Ca(OH)₂ and/or Mg(OH)₂ to precipitate the phytate in the steepwater as described below. Best results may be obtained with calcium hydroxide precipitation. Calcium ions work better to precipitate phosphorus than alternative ions even when the other ions are in a high pH environment.

Light steepwater containing about 1 to about 30% solids, preferably 4-13% solids, and about 0.1 to about 3% phytate, preferably 0.4 to 1.3% phytate, with a pH of about 3.5 to about 4.5 is mixed with a sufficient amount alkaline metal hydroxide, such as lime, and/or ammonium hydroxide (at least about 0.07%, preferably about 0.07 to about 3.0%, most preferably about 0.3 to about 1.0% w/w) to raise the pH of light steepwater to above about 5.5 and to precipitate at least about 75% of total phosphorus in steepwater as phytin and insoluble phosphate, such as calcium phosphate. The method is also effective for precipitating at least about 80% of total oxalate in the steepwater such as insoluble calcium oxalate. Generally, more than about 90% of phytate and about 10 to about 50% of inorganic phosphate are precipitated out of steepwater as the calcium salt, and more than about 90% of the oxalate is precipitated out of steepwater as calcium oxalate. The resulting steepwater containing white calcium phytate/phosphate precipitate and calcium oxalate precipitate is subjected to vacuum filtration or horizontal basket centrifugation to produce a calcium phytate and calcium oxalate product and a low phosphorus steepwater.

These feed ingredients may include, for example, soy hulls, wheat middlings, and other cereal grain fibers, which are by-products from milling. In one embodiment, the other feed ingredients are from corn and include corn bran, cracked corn, extracted cornmeal and distillers' solubles or corn processing by-products to make a high moisture corn gluten feed. Such a high moisture feed will contain from about 30 to about 70 weight percent moisture. Alternatively, the low phosphorus steepwater may be mixed with the other fibrous feed components and then dried and pelletized to a dry feed such as a dry corn gluten feed. This latter dry feed will have about 8 to about 12 weight percent moisture.

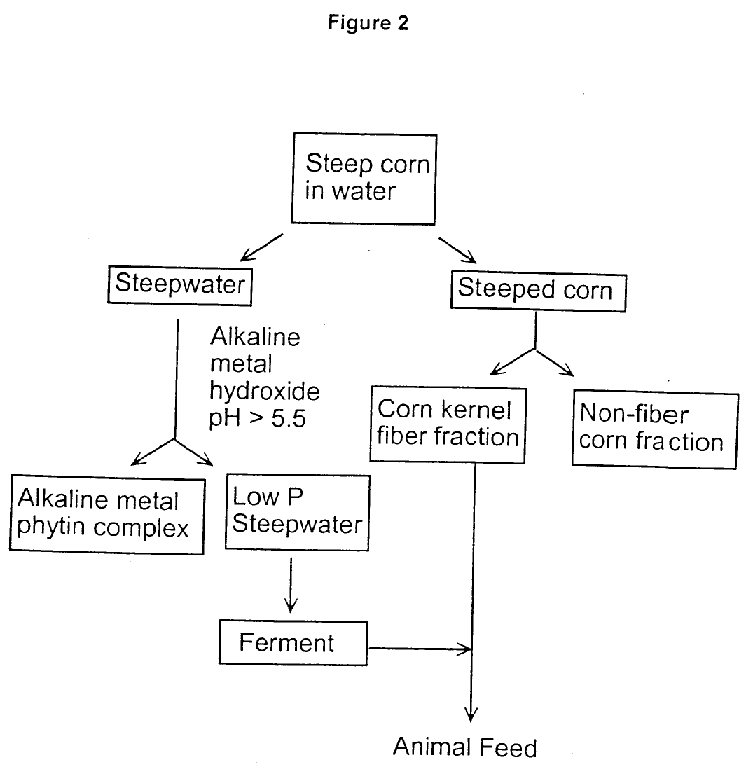

Alternatively and as shown in FIG. 2, the low phosphorus steepwater is fermented using the endogenous steep bacteria (or added lactic acid forming bacteria) at a temperature of at least about 45° C., preferably about 450 to about 55° C. for at least about 8 hours, preferably about 8 to about 48 hours to convert fermentable sugars to lactic acid and to reduce the pH to less than about 5.0 to stabilize the feed. The low pH and low phosphorus steepwater is dried to about 30 to about 90% solids and mixed with other feed ingredients to make a high moisture corn gluten feed. The low pH and low phosphorus steepwater containing feed is dried to about 6 to about 15 weight percent moisture to provide the phosphorus reduced corn gluten feed of the invention having less than about 25 weight percent phosphorus than a comparable corn gluten feed containing untreated steepwater. This feed also may be pelletized. The pH stabilized, low phosphorus steepwater can be used as is or can be dried to about 30 to about 90% solids and used as a fermentation nutrient feedstock or as light steepwater. The pH stabilized, low phosphorus steepwater will have a minimal impact on the mineral metabolism of the fermentation organisms.

Furthermore, the low phosphorous steepwater can be evaporated to about 30 to about 90% solids and combined with other feedstuff to make a generic high moisture low phosphorous animal feed. The high moisture animal feed produced using the low phosphorous steepwater which has been fermented to produce lactic acid and low pH has less mold formation after 5-14 days as compared to high moisture animal feed (more than about 12 weight percent moisture) produced with low phosphorus steepwater or steepwater that has not been fermented. Endogenous and/or added lactic acid bacteria may be utilized to produce lactic acid in the steepwater.

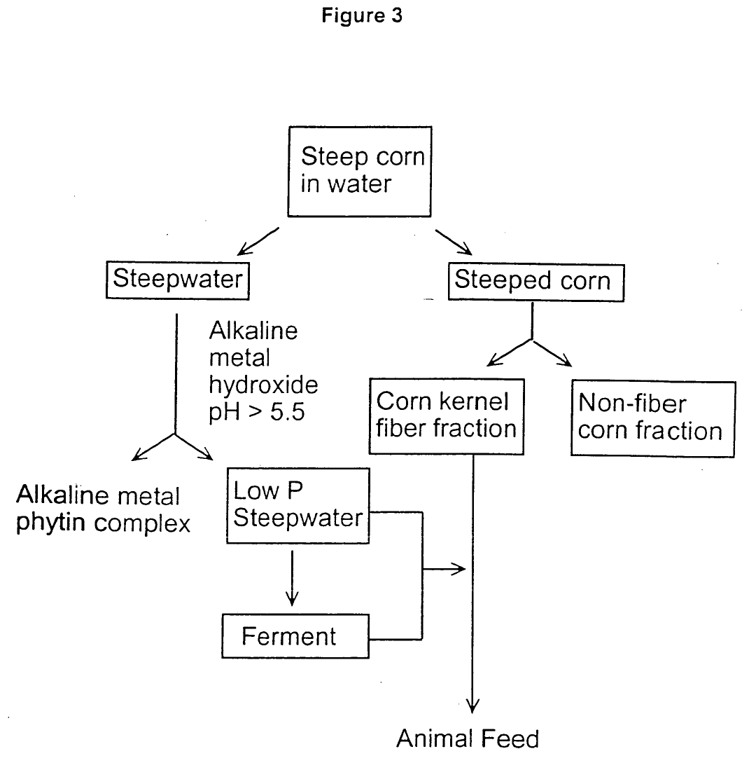

In another aspect of the invention, endogenous and/or propionic acid bateria may be added to the steepwater prior to fermentation. One example of propionic acid bacteria that may be utilized in the process is Propionibacterium acidipropionici strain ATCC 55737. As shown in FIG. 3, a portion of the low phosphorous steepwater may be fermented and then recombined with the remaining low phosphorus steepwater. In this aspect of the invention, an amount of steepwater is fermented such that when the fermented steepwater is recombined with the remaining steepwater and used to produce a high moisture animal feed, the feed has from about 1 to about 4 lbs. of propionate per ton of feed. The high moisture animal feed produced using low phosphorous steepwater which has been fermented to produce propionate has less mold formation after 5-14 days as compared to an animal feed produced with low phosphorous steepwater or steepwater that has not been fermented to produce propionate. The fermented low phosphorous, high propionate containing steepwater may also be held separately for other uses.

To complete the milling and separation of the corn components downstream from the steeping step, dewatered corn is metered into coarse grinding mills which generally have one stationary and one rotating disk. The disks have knobs that break up the corn kernel. Clearance between the disks is adjusted so that a few whole kernels but few broken germs are in the mill discharge. The diluted slurry from the mills is pumped to flotation tanks or hydroclones, where oil-bearing germ is floated off the top. These are routed to a series of 50° screens that are used to wash the germ, with the addition of wash water. The recovered germ is then dewatered such as in screw press, dried, and further processed to recover the corn oil.

After germ separation with flotation or hydroclones, the remaining corn slurry is screened to separate fiber, generally from pericarp, from the starch and gluten. From about 30 to about 40 weight percent of the starch is separated from the pericarp at this point.

The remaining stream includes fiber with some attached starch. Further milling frees the starch with minimum fiber breakup. The milled slurry then is washed and screened to separate the starch from the fiber. Washed fiber from this wash stage is only about 10 to about 15 weight percent solids. Further dewatering may be accomplished by mechanical means to about 40 weight percent solids.

### EXAMPLES

### Example I

(Method of Making Low Phosphorus Reduced Steepwater)

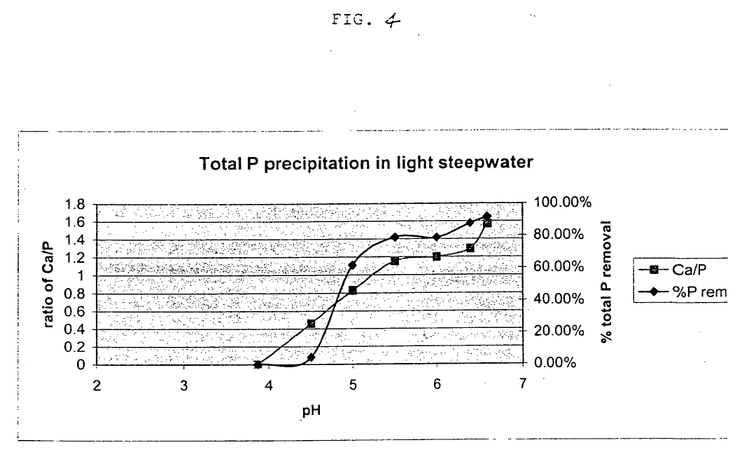

Various amounts of lime (calcium hydroxide) is added to light steepwater at about 50 to about 60° C. with mixing to precipitate phytate. The mixture is filtered through a filter under vacuum to remove precipitate solids. The total phosphorus content can be measured by various analytical methods. One analytical method involves the use of phytase to hydrolyze phytate to free phosphates and measuring free phosphates with an ion chromatography. The phytase hydrolysis reaction of the analytical method is done at about 37° C. for 4 hours in 0.2 M citrate buffer with a pH of 5.0. Under these analytical conditions, 96% of total phosphate is hydrolyzed from phytate. FIG. 4 shows the amount of phosphorus precipitated out of steepwater at various pH's and calcium to phosphorus ratio. More than 80% of total phosphorus in steepwater is precipitated out at pH>5.5 and calcium to phosphorus molar ratio of >0.75 in this example. The calcium phytate precipitate collected at pH=6.4 is analyzed to contain 11% protein, 56% ash, 13.9% calcium, 17.6% phosphorus, 3.6% magnesium, and 1.6% sulfur. The starting steepwater solids contain 3.6% phosphorus and the low phosphorus steepwater solids contain only 0.5% phosphorus. More than 85% of total phosphorus is removed from the steepwater.

Steepwater from another source was also processed as indicated above. Results of processing were as follows.

| | | % P | % oxalate |
|---|---|---|---|
| pH | Ca/PO4 | removed | removed |
| 6.14 | 1.58 | 87.4 | 92.8 |
| 5.62 | 1.42 | 83.6 | 89.4 |
| 5.29 | 1.25 | 69.0 | 81.8 |
| 5.07 | 1.10 | 52.7 | 84.9 |
| 4.95 | 0.95 | 40.5 | 82.1 |
| 4.76 | 0.79 | 10.2 | 81.2 |
| 4.56 | 0.63 | 2.1 | 89.2 |
| 4.37 | 0.47 | 7.5 | 90.3 |
| 4.14 | 0.33 | 3.7 | 85.7 |
| 4.10 | 0.16 | 0 | 64.9 |
| 3.97 | 0.03 | 3.3 | 0 |

### Example II

(Method of Making a Fermented pH Stabilized Steepwater)

Low phosphorus steepwater is incubated at 52° C. for 24 hours with gentle mixing. Approximately 5 g/L reducing sugars are converted to 5 g/L lactic acid during the fermentation and the pH of low phosphorus steepwater dropped from 6.4 to 4.4. Low phosphorus steepwater is evaporated under vacuum to 50% solids to produce a low phosphorus corn steep liquor that is blended with other feed ingredients to make corn gluten feed.

The following are examples of corn gluten feed formulation containing this low phosphorus pH stabilzed steepwater. Other formulations of corn gluten feed and animal feeds may be used with this low phosphorus steepwater to make low phosphorus animal feed.

### Example III

A high moisture low phosphorus corn gluten feed is made with 34 weight percent corn bran, 24 weight percent solvent extracted germ meal, 5 weight percent cracked corn, 10% distillers' solubles, and 27 weight percent low phosphorus steepwater, based on the dry weight basis of the feed. The typical corn gluten feed made with untreated steepwater contains 1.13% total phosphorus and the low phosphorus feed as described above contains 0.27% total phosphorus which is a 76% reduction in phosphorus.

### Example IV

A low phosphorus corn gluten feed is made with 63 weight percent corn bran, and 37 weight percent low phosphorus steepwater, based on the dry weight basis of the feed. The typical corn gluten feed made with untreated steepwater contains 1.34% phosphorus and the low phosphorus corn gluten feed as described in this example contains 0.18% phosphorus which is a 86% reduction in phosphorus.

### Example V

A low phosphorus corn gluten feed is made with 48 weight percent corn bran, 12% cracked corn and 40 weight percent low phosphorus steepwater, based on the dry weight basis of the feed. The typical corn gluten feed of this formulation with untreated steepwater contains 1.48% phosphorus and the low phosphorus corn gluten feed in this example contains 0.21% phosphorus which is a 86% reduction in phosphorus.

### Example VI

Evaporated steepwater (all at 50% DS) with (LSW control) and without (low-P steep) phytate at neutral and acidic pH (low-P steep fermented) was mixed with other feed ingredients as in Example III to make a high moisture corn gluten feed. The feed was incubated at 35° C. for 9 days to study its stability. Feed was visually inspected for mold and scored on a scale of 0-5, with 5 meaning that the feed was covered with molds.

| | | LSW | LSW- | LSW-phytate |
|---|---|---|---|---|
| | LSW | ferment | phytate | ferment (low |
| | (Control) | (Control ferm) | (Low P) | P steep ferm) |
| starting pH | 4.22 | 3.74 | 6.19 | 3.96 |
| temp. of feed | | | | |
| 2-day | 32.3 | 32 | 32.5 | 31.9 |
| 5-day | 37.3 | 38.2 | 37.4 | 33.8 |
| 9-day | 34.4 | 33.4 | 32.7 | 32.9 |
| mold score | | | | |
| 1-day | 0 | 0 | 0 | 0 |
| 2-day | 0 | 0 | 0 | 0 |
| 5-day | 4.5 | 3.3 | 3.3 | 0 |
| 6-day | 4.83 | 4.17 | 3.67 | 1 |
| 7-day | 5 | 4.67 | 4.17 | 3 |
| 8-day | 5 | 5 | 4.5 | 4 |
| 9-day | 5 | 5 | 5 | 4.83 |

### Example VII

Propionibacterium acidipropionici strain ATCC 55737 was used to ferment low phosphorous steepwater to propionate containing low phosphorus steepwater. Propionate is typically used as a feed preservative and low phosphorous steepwater was a good fermentation medium for propionate production. The fermentation was carried out at 30° C. with mild mixing with 10% inoculum pregrown in a standard defined medium. No other nutrient source was used other than low phosphorus steepwater. The fermentation profile is as shown below. The fermented low phosphorus steepwater has a low pH and high propionate concentration and can be used as a feed preservative in an animal feed.

| Low P LSW | | | g/L | | |
|---|---|---|---|---|---|
| Time (h) | pH | OD | Prop | glu | lac |
| 0 | 5.5 | 9.641 | 2.56 | 11.92 | 18.75 |
| 24 | 5.19 | 12.493 | 3.54 | 12.59 | 16.24 |
| 48 | 4.99 | 14.694 | 6.67 | 11.54 | 13.8 |
| 120 | 4.79 | 18.91 | 14.41 | 3.64 | 9.07 |

### Example VIII

Flasks (500 ml) containing 200 ml of medium that included 220 g/L glucose, 90 g/L steepwater or low phosphorus steepwater, and 10 g/L urea were inoculated with a commercial ethanol fermentation yeast. Fermentation was conducted at 30° C. with mild mixing. There was no difference in sugar utilization rate or ethanol production rate between steepwater or low phosphorus steepwater.

1. A method for making an animal feed comprising:
mixing steepwater with a hydroxide selected from the group consisting of calcium hydroxide, magnesium hydroxide, ammonium hydroxide, and mixtures thereof to provide a phosphorus precipitated steepwater, the hydroxide being in an amount effective to precipitate the phosphorus in the steepwater and to provide a phosphorus complex;
separating the phosphorus complex and steepwater to provide a second steepwater; and
combining the second steepwater with an animal feed to provide steepwater containing animal feed.

2. The method of claim 1 wherein the animal feed is selected from the group consisting of cereal grains, cereal grain by-products, legumes, legume by-products, and mixtures thereof.

3. The method of claim 2 wherein the cereal grain by-product is a processing by-product from milling of corn.

4. The method as recited in claim 1 wherein the hydroxide is in an amount to precipitate at least 75 weight percent of phosphorus in the steepwater.

5. The method as recited in claim 1 wherein the hydroxide is calcium hydroxide and the calcium hydroxide is in an amount to provide the steepwater with a pH of greater than 5.5 and a Ca/P molar ratio of at least 1.0.

6. The method as recited in claim 1 wherein at least 0.07 weight % hydroxide is mixed with the steepwater.

7. The method as recited in claim 1 wherein the hydroxide is calcium hydroxide.

8. The method as recited in claim 1 wherein the second steepwater is fermented for a time and at a temperature which is effective to convert carbohydrates in the second steepwater into lactic acid and to reduce the pH of the second steepwater to less than 5.

9. The method as recited in claim 8 wherein the fermentation is conducted at a temperature of at least 45° C. for at least 8 hours.

10. The method as recited in claim 8 wherein the second steepwater is fermented with endogenous bacteria.

11. The method as recited in claim 8 wherein the second steepwater is fermented with lactic acid bacteria.

12. The method as recited in claim 8 wherein the second steepwater is fermented with propionate producing bacteria.

13. An animal feed made by the process of claim 1.

14. An animal feed as recited in claim 13 wherein the animal feed is corn gluten feed.

15. An animal feed comprising a steepwater effective for providing the feed with a phosphorus content which is not more than 25 weight percent of the phosphorus content of an animal feed made with a second steepwater which has not been reduced in phosphorus content.

16. The feed as recited in claim 15 wherein the animal feed comprises steepwater with at least 75 weight % of the phosphorus removed.

17. The feed as recited in claim 15 wherein the steepwater is a fermented steepwater.

18. The feed as recited in claim 15 wherein the feed is a high moisture feed and the high moisture feed has less mold after 5 days as compared to a high moisture feed that does not include a fermented steepwater having a reduced phosphorus content.

19. A method of making steepwater comprising:
mixing steepwater with a hydroxide selected from the group consisting of calcium hydroxide, magnesium hydroxide, ammonium hydroxide, and mixtures thereof at a pH greater than 5.5 to provide a phosphorus precipitated steepwater, the hydroxide being in an amount effective to precipitate at least 75 weight percent of phosphorus in the steepwater and to provide a phosphorus complex;
separating the phosphorus complex and phosphorus precipitated steepwater to provide a second steepwater; and
fermenting the second steepwater for a time and at a temperature which is effective to convert carbohydrates in the second steepwater into lactic acid and to reduce the pH of the second steepwater to less than 5 to provide a fermented steepwater.

20. The method as recited in claim 19 wherein the hydroxide is calcium hydroxide and the calcium hydroxide is in an amount to provide the steepwater with a pH of greater than 5.5 and a Ca/P molar ratio of at least 1.0.

21. The method as recited in claim 19 wherein at least 0.07 weight % hydroxide is mixed with the steepwater.

22. The method as recited in claim 19 wherein the hydroxide is calcium hydroxide.

23. The method as recited in claim 19 wherein the fermentation is conducted at a temperature of at least 45° C. for at least 8 hours.

24. The method as recited in claim 19 wherein the second steepwater is fermented with endogenous bacteria.

25. The method as recited in claim 19 wherein the second steepwater is fermented with lactic acid bacteria.

26. The method as recited in claim 19 wherein the fermented steepwater is combined with an animal feed.

27. The method as recited in claim 19 wherein the hydroxide is effective for precipitating oxalate in the steepwater to oxalate complexes.

28. The method as recited in claim 19 wherein 80 weight % of the oxalate in the steepwater is precipitated.

29. The method as recited in claim 19 wherein the fermentation is effective for producing propionate.

30. The method as recited in claim 30 wherein a portion of the second steepwater is fermented and recombined with the remainder of the second steepwater.

31. The method as recited in claim 19 wherein the second steepwater is fermented with microbes in addition to lactic acid bacteria.

32. A fermented steepwater made by the process of claim 19.

33. A process for preparing a fermentation product, the process comprising fermenting a steepwater having a phosphorus content that is not more than 25 percent of the phosphorus content of a source steepwater from which the steepwater has been obtained which has not been reduced in phosphorus.

34. A method of making steepwater:
mixing steepwater with a hydroxide selected from the group consisting of calcium hydroxide, magnesium hydroxide, ammonium hydroxide, and mixtures thereof at a pH greater than 5.5 to provide a phosphorus precipitated steepwater, the hydroxide being in an amount effective to precipitate at least 75 weight percent of phosphorus in the steepwater and to provide a phosphorus complex;
separating the phosphorus complex and phosphorus precipitated steepwater to provide a second steepwater; and
fermenting the second steepwater with propionate producing bacteria.

35. The method as recited in claim 34 wherein the second steepwater is fermented microbes in addition to propionate producing bacteria.
